(19) United States
(12) Patent Application Publication
(10) Pub. No.: US 2003/0034053 A1
(43) Pub. Date: Feb. 20, 2003

(54) Processing and cleaning method

(76) Inventors: Kazuaki Nishimura, Kanagawa-Ken (JP); Hiroyuki Yamamoto, Kanagawa-ken (JP); Phillip Spaull, Kanagawa-ken (JP)

Correspondence Address: SMITH, GAMBRELL & RUSSELL, LLP, Beveridge DeGrandi, Weilacher & Young, Intellectual Property Group, 1850 M Street, N.W., Suite 800, Washington, DC, 20036, US

(21) Appl. No.: 09/801,862

(22) Filed: Dec. 21, 2000

(30) Foreign Application Priority Data
Dec. 22, 1999 (JP) 1999-364382

(51) Int. Cl. B44C 1/22; C01B 33/08; C23G 5/00

(52) U.S. Cl. 134/19; 423/342; 423/343; 216/67

(57) ABSTRACT

The method according to the present invention enables to suppress damaging the reaction tubes and the wafer boat made of quarts, when cleaning the reaction vessel after the completion of film forming process for a polysilicon or titanium nitride film, thus the method reduces the running cost. After forming a polysilicon film on the semiconductor wafers, the empty wafer boat is placed in the reaction vessel. The interior atmosphere of the reaction vessel is maintained at temperatures in the range of 700 to 1000° C. A mixed gas prepared by diluting chlorine gas with nitrogen gas is supplied at a predetermined flow rate into the reaction vessel to remove the polysilicon film. A titanium nitride film can also be removed in the same manner.

### BACKGROUND OF THE INVENTION

1. Field of the Invention

The present invention relates to techniques of cleaning a reaction vessel and the associated equipment, which are used for carrying out a film forming process, an etching process or the like to an object.

2. Description of the Related Art

A semiconductor device fabricating process includes a film forming process for forming a film, such as a polysilicon film that is used as the electrode of MOS transistors and the like or a barrier film of TiN (titanium nitride) for preventing the corrosion and diffusion of metal wiring lines, on a semiconductor wafer (hereinafter referred to simply as “wafer”). A vertical or horizontal thermal treatment system is used for carrying out such a film forming process by a batch processing. Vertical thermal treatment systems are used prevalently in recent years because they are less subject to the effect of the atmosphere.

The vertical thermal treatment system has a heating furnace formed by surrounding a vertical reaction tube of a ceramic material, such as quartz, by an electric resistance heater. A wafer boat of a ceramic material, such as quartz, supporting a plurality of wafers W is carried into the heating furnace by a boat elevator, and a predetermined reactive gas is introduced into the reaction tube for film deposition.

When the film forming process is repeated, silicon and titanium nitride films are deposited on the reaction tube and the wafer boat. The films are also deposited on an insulting member of quartz or the like called a heat insulating tube disposed below the wafer boat. The thickness of such films increases gradually. If the films are left unremoved, when the wafer boat is carried into and carried out of the reaction tube, the films come off the reaction tube, the wafer boat or the heat insulating tube and float. Then, the wafers W are contaminated with particles originating from the fallen films, which reduces yield.

To avoid such contamination, an empty wafer boat is carried into a reaction tube, the reaction tube is heated. A cleaning gas, such as chlorine trifluoride gas (ClF₃ gas) is introduced into the reaction chamber to remove the films deposited on the inner surface of the reaction tube and the like by the etching action of the chlorine trifluoride gas.

Since the etching action of chlorine trifluoride gas is strong, the surface of wall of quartz, which is exposed after the films have been removed, is eroded. Since the surface of the reaction tube, the wafer boat and the heat insulating tube are coated with films of different qualities and different thicknesses, respectively, the films are not etched uniformly. In addition, a cleaning time is determined to be somewhat long so that all the films can be completely removed. Thus, the exposed parts of the surface are contact with the chlorine trifluoride gas and are eroded. Structures formed by processing quartz, such as reaction vessels, wafer boats or heat insulating tubes, are expensive, and hence the shortening of useful life affects the cost disadvantageously.

The reduction of the etching action by lowering the temperature of the reaction tube is effective in avoiding such a problem, which, however, increases time necessary for the cleaning process.

Moreover, the cleaning process is one of the factors that increases the running cost because chlorine trifluoride gas is an expensive gas and the cleaning process is performed frequently. Chlorine trifluoride gas contains fluorine (F) and free fluorine is highly corrosive to metal wiring lines. Therefore it is possible that the use of chlorine trifluoride gas that may possibly introduce free fluorine into semiconductor devices cause troubles.

### SUMMARY OF THE INVENTION

Accordingly, it is an object of the present invention to provide a cleaning method capable of suppressing damaging a reaction vessel and a holder, which is configured to hold the object to be processed, when cleaning the interior of the reaction vessel after the completion of a film deposition process for depositing a polysilicon film or a titanium nitride film or an etching process for etching the films, and capable of reducing the running cost of the processing system. Another object of the present invention is to provide a processing and cleaning method of carrying out a series of processes including a film deposition process or an etching process and a cleaning process.

With the foregoing object in view, the present invention is characterized in that chlorine gas is used as a cleaning gas, and the wall of the reaction vessel, i.e., the object to be cleaned, is heated at a temperature in the range of 700 to 1000° C. Under this condition, the chlorine gas reacts with the deposits, thereby deposits deposited on the inner surface of the wall of the reaction vessel are removed therefrom. The pressure in the reaction vessel during the reaction may be in the range of 1 to 400 Torr. The holder may be placed in the reaction vessel during the cleaning process in order to clean the reaction vessel and the holder together.

The lower limit of the cleaning temperature is 700° C., because cleaning is impossible or the cleaning process proceeds at a very low rate when the cleaning temperature is below 700° C. The upper limit of the cleaning temperature is 1000° C., because it takes an excessively long time for heating a structure to be cleaned to that high temperature and to cool the same from that high temperature and hence the throughput of the processing system is reduced.

Since the present invention uses chlorine gas as a cleaning gas, damaging the reaction vessel, the object and the holder can be suppressed and the running cost can be reduced because chlorine gas is inexpensive.

### BRIEF DESCRIPTION OF THE DRAWINGS

FIG. 1 is a longitudinal sectional view of a vertical thermal treatment system employed in carrying out a processing and cleaning method in a preferred embodiment according to the present invention;

FIG. 2 is a schematic perspective view of the vertical thermal treatment system employed in carrying out the processing and cleaning method embodying the present invention;

FIG. 3 is a schematic longitudinal sectional view of assistance in explaining removal of polysilicon films deposited on the inner surfaces of a reaction vessel by a cleaning process using chlorine gas;

FIG. 4 is a graph showing a temperature control pattern for a film deposition process for depositing a polysilicon film and a subsequent cleaning process;

FIG. 5 is a graph showing a temperature control pattern for a film deposition process for depositing a titanium nitride film and a subsequent cleaning process; and

FIG. 6 is a graph showing the relation between etch rate, temperature and processing time when a polysilicon film is etched with chlorine gas.

### DESCRIPTION OF THE PREFERRED EMBODIMENTS

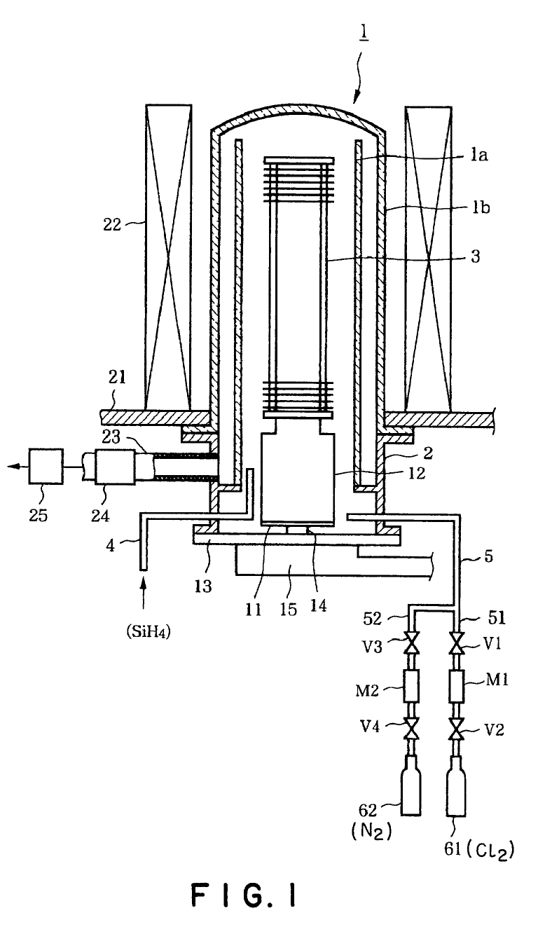

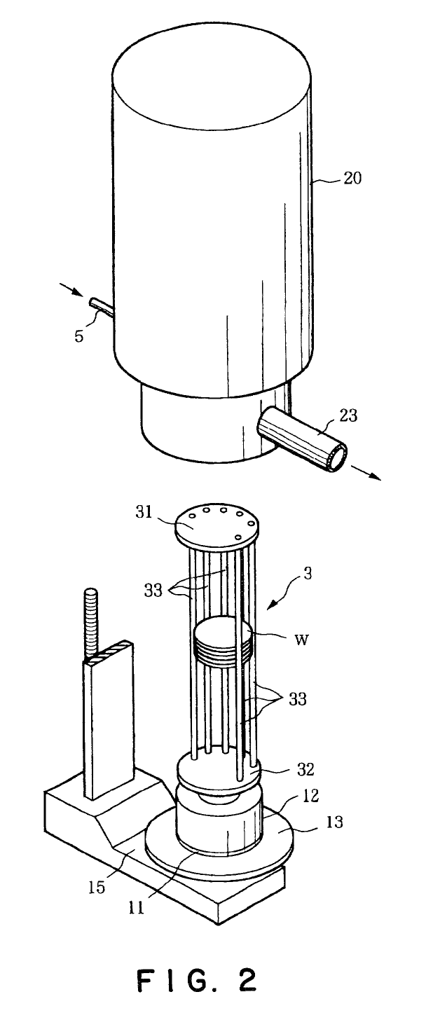

A vertical thermal processing system for carrying out a processing and cleaning method in a preferred embodiment according to the present invention will be described with reference to FIGS. 1 and 2.

A reaction tube 1 is a double-tube structure including a quartz inner tube 1a and a quartz outer tube 1b. A tubular metal manifold 2 is disposed under the reaction vessel 1. The inner tube 1a has an open end and is supported on the manifold 2. The outer tube 1b has a closed upper end and a lower end closely joined to the upper end of the manifold 2 in an airtight fashion. The inner tube 1a, the outer tube 1b and the manifold 2 constitute a reaction vessel. Indicated at 21 is a base plate.

A wafer boat 3 is disposed in the reaction tube 1. The wafer boat 3 is capable of holding a plurality of wafers W, i.e., substrates, for example, about sixty wafers W, in a horizontal position at vertical intervals. The wafer boat 3 is made of quartz. As shown in FIG. 2, the wafer boat 3 has a top plate 31, a bottom plate 32 and a plurality of support rods 33 vertically extended between the top plate 31 and the bottom plate 32. The support rods 33 are provided with grooves to receive peripheral parts of wafers W.

The wafer boat 3 is mounted on a turntable 11 via a heat insulating tube (heat insulating member) 12 made of quartz. A shaft 14 extended through a lid 13 is connected to the turntable 11. The shaft 14 is driven for rotation to rotate the turntable 11. The lid 13 is mounted on a boat elevator 15 for carrying the wafer boat 3 into and carrying out the same from the reaction tube 1. When raised to an uppermost position, the lid 13 closes the lower open end of the manifold 2, i.e., the lower open end of the reaction vessel including the reaction tube 1 and the manifold 2. The boat elevator 15 is provided with a driving mechanism (not shown) for driving the shaft 14 for rotation. The reaction tubel is surrounded by a heater 22. In FIG. 2, indicated at 20 is a heating furnace formed by surrounding the heater 22 by a heat insulating structure.

A plurality of gas supply pipes are connected at circumferential intervals to the manifold 2. In FIG. 1, only two gas supply pipes 4 and 5 among the plurality of gas supply pipes are shown for simplicity. The film forming gas supply pipe 4 carries a film forming and the cleaning gas supply pipe 5 carries a cleaning gas.

The cleaning gas supply pipe 5 branches into two branch pipes 51 and 52. The branch pipe 51 is provided with a valve V1, a flowmeter M1 and a valve V2, and is connected to a chlorine gas source (Cl₂ gas source) 61. The branch pipe 52 is provided with a valve V3, a flow meter M2 and a valve V4, and is connected to a nitrogen gas source (N₂ gas source) 62. A mixed gas prepared by mixing chlorine gas, i.e., a cleaning gas, and nitrogen gas, i.e., a diluting gas, can be carried by the cleaning gas supply pipe 5 into the reaction vessel. Preferably, the flow rate ratio between chlorine gas and nitrogen gas, i.e., (Chlorine gas flow rate)/(Nitrogen gas flow rate), is in the range of 1/1 to 1/4.

Chlorine gas is diluted with nitrogen gas to suppress chlorine gas consumption and to stabilize the pressure in the reaction vessel during a cleaning process. Cleaning effect does not increase according to chlorine gas flow rate after chlorine gas flow rate has exceeded a certain level. Therefore, chlorine gas flow rate is not increased too high in view of suppressing the running cost and is in the range of, for example, about 1.0 to about 3 SLM. However, it is difficult to stabilize the pressure in the reaction vessel by supplying chlorine gas at such a flow rate. Therefore, nitrogen gas is added to chlorine gas to supply the mixed gas at a flow rate high enough to stabilize the pressure in the reaction vessel. Chlorine gas may be supplied into the reaction vessel without diluting the same with an inert gas. An inert gas other than nitrogen gas may be used as a diluting gas.

Although the vertical thermal processing system shown in FIG. 1 is provided with the film forming gas supply pipe 4 and the cleaning gas supply pipe 5, the cleaning gas may be supplied through the film forming gas supply pipe 4. When the film forming gas supply pipe 4 is to be used also for carrying the cleaning gas, branch pipes branched out from the film forming gas supply pipe 4 are connected to the chlorine gas source and the nitrogen gas source, respectively.

A discharge pipe 23 is connected to the manifold 2 to evacuate the space between the inner tube 1a and the outer tube 1b. The discharge pipe 23 is connected through a pressure regulator 24 that regulates the pressure in the reaction vessel to a vacuum pump 25.

Operation of the system will be described.

A film forming process for forming a polysilicon film on wafers W will be explained. The wafer boat 3 holding a plurality of wafers W is carried into the reaction tube 1 by the boat elevator 15, the heater 22 is energized to heat the atmosphere in the reaction tube 1 at 620° C., and the vacuum pump 25 is actuated to evacuate the interior of the reaction tube 1 to a predetermined vacuum.

Subsequently, a mixed gas prepared by diluting monosilane gas (SiH₄ gas), i.e., a film forming gas, with nitrogen gas is supplied through the film forming gas supply pipe 4 into the reaction vessel and the interior of the reaction vessel is maintained at the predetermined vacuum. The wafer boat 3 is rotated at a predetermined rotating speed. The monosilane gas blown through the film forming gas supply pipe 4 into the reaction vessel is decomposed as it flows upward in the inner tube 1a. Then, the monosilane gas turns downward at the upper open end of the inner tube 1a, flows downward through the space between the inner tube 1a and the outer tube 1b, and is discharged through the discharge pipe 3. The decomposition product of the monosilane gas is deposited on the wafers W to form a polysilicon film. This film depositing process is continued for a predetermined time to deposit a polysilicon film of a desired thickness of, for example, 30 nm. Subsequently, an inert gas, such as nitrogen gas is supplied into the reaction vessel to replace the atmosphere in the reaction vessel with the inert gas to set the interior of the reaction vessel at the atmospheric pressure. Nitrogen gas may be supplied from the nitrogen gas source 62 connected to the cleaning gas supply pipe 5 or nitrogen gas may be supplied through another gas supply pipe (not shown) connected to the manifold 2. After the interior of the reaction vessel has been cooled to a predetermined temperature, the wafer boat 3 is carried out of the reaction vessel.

The monosilane gas supplied into the reaction vessel diffuses in the reaction vessel and, consequently, polysilicon films are deposited not only on the wafers W but also on the surfaces of the reaction tube 1, the wafer boat 3 and the heat insulating tube 12. Since the temperatures of the manifold 2 and the lid 13 are low, less polysilicon is deposited on the manifold 2 and the lid 13. As the film forming process is repeated, the thickness of the polysilicon films deposited on the surfaces of the reaction tube 1, the wafer boat 3 and the heat insulating tube 12 grows large and the thick polysilicon films come off those surfaces as mentioned above. To avoid the polysilicon films coming off the surfaces, it is preferable to clean the surfaces before the thickness grows to about 10 μm. The number of cycles of the film forming process in which the thickness of the polysilicon films increases to a value slightly below 10 μm is determined through experiments, and the surfaces are cleaned after the number of cycles of the film forming process has reached the predetermined number of cycles determined through experiments.

A cleaning process will be explained hereinafter.

First an empty wafer boat 3 is carried into the reaction vessel by the boat elevator 15.

Then, the atmosphere in the reaction vessel and hence the inner surfaces of the reaction vessel and the surface of the wafer boat 3 are heated at temperatures in the range of 700 to 1000° C., preferably, in the range of 700 to 800° C. and the reaction vessel is evacuated to a predetermined vacuum. Subsequently, a mixed gas prepared by mixing chlorine gas and nitrogen gas is supplied through the cleaning gas supply pipe 5 into the reaction vessel and the pressure in the reaction vessel is maintained at pressures in the range of 1 to 400 Torr, preferably, at pressures on the order of 1 Torr. This state is maintained, for example, for 3 hr.

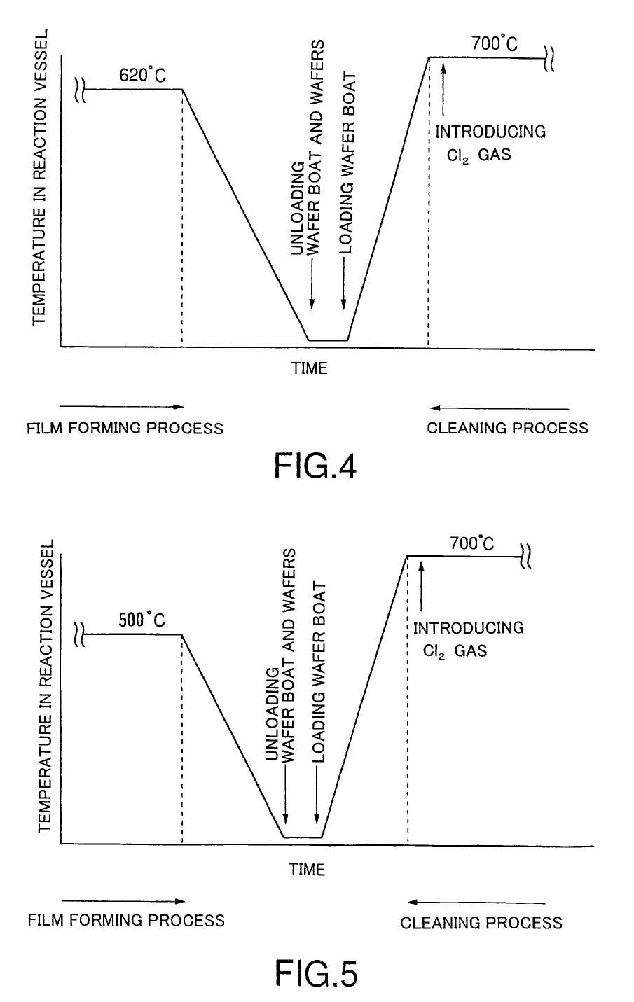

In the above process, the chlorine gas reacts with the polysilicon films deposited on the reaction vessel (the reaction tube 1 and the manifold 2), the wafer boat 3, the heat insulating tube 12 and the lid 13. Consequently, the polysilicon films are vaporized and removed. The series of steps of the film forming process and the cleaning process are illustrated in FIG. 4.

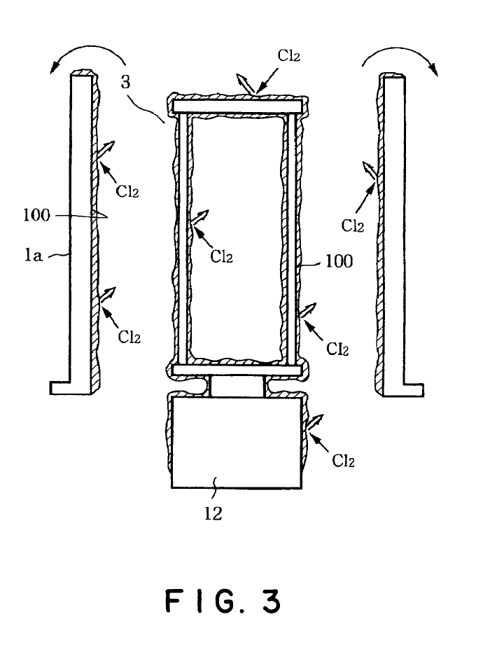

FIG. 3 shows mode of cleaning the interior of the reaction vessel of polysilicon films 100. It is considered that a reaction expressed by Estimated reaction formula (1) occurs during the cleaning process.

Si+2Cl₂→SiCl₄ (1)

The film forming process may use dichlorosilane gas (SiH₂Cl₂ gas) instead of monosilane gas. When dichlorosilane gas is used, some part of hydrogen atoms (H) contained in the film forming gas is included in the polysilicon film. Therefore, it is considered that some part of silicon produces a compound together with chlorine and hydrogen, and the compound is gasified.

The aforesaid cleaning process supplies chlorine gas into the reaction tube and, at the same time, the discharges the atmosphere in the reaction tube; that is, chlorine gas flows through the reaction tube during the cleaning process. The mode of the cleaning process is not limited thereto; the discharging of the atmosphere in the reaction tube may be stopped and chlorine gas may be stagnated in the reaction tube during the cleaning process or chlorine gas may be alternately stagnated and flowed.

Thus, the polysilicon films deposited on the inner surfaces of the reaction tube 1 and surface of the wafer boat 3 placed in the reaction vessel can be removed by the cleaning process using chlorine gas as a cleaning gas (please refer to the examples described later). Since quartz is substantially not etched at all by chlorine, the useful life of the reaction tube 1, the wafer boat 3 and the heat insulating tube 12, which are expensive quartz structures, can be extended. The cost of chlorine gas is about 1/10 of the chlorine trifluoride, which has been used as a cleaning gas, and hence the use of chlorine gas as a cleaning gas reduces the running cost of the thermal processing system. Chlorine gas not containing fluorine gas does not affect adversely to semiconductor devices.

A descripton will be given of a film forming process and a cleaning process when a titanium nitride film is formed on wafers.

A film forming process for forming a titanium nitride film on wafers W is carried out in a process atmosphere heated at about 500° C. The pressure in the reaction vessel is set at a predetermined vacuum while titanium tetrachloride gas (TiCl₄ gas) and ammonia gas (NH₃ gas) are supplied through two pipes, not shown FIGS. 1 and 2, connected to the manifold 2. Titanium tetrachloride gas and ammonia interact to deposit, for example, 5 nm thick titanium nitride film on the wafers W.

As the film forming process is repeated, the thickness of the titanium nitride films deposited on the surfaces of the reaction tube 1, the wafer boat 3 and the heat insulating tube 12 grows large and the thick titanium nitride films come off those surfaces as mentioned above. To avoid the titanium nitride films coming off the surfaces, the surfaces are cleaned of the deposited titanium nitride films by a cleaning process, which is similar to that for cleaning the surfaces of the polysilicon films, by supplying a mixed gas prepared by diluting chlorine gas with nitrogen gas into the reaction vessel. Since the titanium nitride film is comes off the surfaces more easily than the polysilicon film, it is preferable to execute the cleaning process upon the increase of the thickness of the titanium nitride films deposited on the surfaces to about 2 μm. In the cleaning process for removing the deposited titanium nitride films, chorine gas and nitrogen gas may be supplied at the aforesaid flow rates mentioned in connection with the cleaning process for removing the deposited polysilicon films, the temperature of the atmosphere may be in the range of 700 to 1000° C.,preferably, 700° C., and the pressure in the reaction vessel is in the range of 1 to 400 Torr, preferably, about 1 Torr.

The cleaning process gasifies and removes the titanium nitride films deposited on the reaction tube 1, the manifold 2, the waferboat 3 and the heat insulating tube 13. It is considered that a reaction expressed by Estimated reaction formula (2) occurs during the cleaning process for removing the deposited titanium nitride films.

TiN+2Cl₂→TiCl₄+N (2 )

The effect of the cleaning process using chlorine gas for cleaning the interior of the reaction vessel after the film forming process for forming the titanium nitride film is the same as that of the cleaning process after the film forming process for forming the polysilicon films. The series of steps of the film forming process and the cleaning process are illustrated in FIG. 5.

The material of the reaction tube 1, the wafer boat 3 and the heat insulating tube 12 is not limited to quartz; the material may be silicon carbide or the like. The wafer boat 3 and the heat insulating tube 12 may be cleaned by a wet cleaning process and do not need to be mounted on the boat elevator 15 during the cleaning process using chlorine gas. The films to be removed by the cleaning process are not limited to those deposited on the surfaces in the reaction vessel during the film forming process. The films to be removed by the cleaning process may include by-products of an etching process, i.e., fragments of the polysilicon films and the titanium nitride films scattered during the etching process that dry-etches polysilicon films and titanium nitride films with an etching gas. The cleaning process is applicable not only to batch type thermal processing systems including vertical thermal processing systems but also to film forming systems and etching systems of a single wafer processing system. The objects are not limited to wafers but may be glass substrates for liquid crystal displays. Silicon films mentioned herein are not only polysilicon films but include amorphous silicon film and single-crystal silicon films.

### EXAMPLES

### Example 1

A polysilicon film was formed on a wafer and the wafer was subjected to an etching process using the aforesaid vertical thermal processing system and chlorine gas as an etching gas to examine the etching effect of chlorine gas on a polysilicon film. The etching effect was evaluated in terms of etch rate. A sample wafer of 200 mm in diameter having a surface coated with a 228 nm (2280 Å) thick polysilicon film was placed in a middle part of a wafer boat capable of supporting 126 wafers of 200 mm diameter, and two dummy wafers were placed at positions in the wafer boat spaced a distance corresponding to four pitches of the grooves formed in each support rod of the wafer boat apart upward and downward, respectively, from the wafer coated with the polysilicon film. The wafer boat thus holding the sample wafer and the dummy wafers was carried into the reaction vessel. The process atmosphere in the reaction vessel was heated at 800° C. and was maintained at 133 Pa, the wafer boat was rotated at 3 rpm, and chlorine gas and nitrogen gas were supplied at 1800 sccm and 3200 sccm, respectively, into the reaction vessel for an etching process. The etching process was continued for five minutes. The sample wafer was taken out of the reaction vessel and the thickness of the polysilicon film was measured. The silicon film was etched and removed completely from the sample wafer. Thus, an estimated etch rate was 228 nm/5 min=45.6 nm/min. However, since the polysilicon film had been removed by time five minutes after the start of the etching process, it is considered that the polysilicon film was removed completely in a time shorter than five minutes. Therefore, the actual etch rate is greater than 45.6 nm/min.

### Example 2

A sample wafer similar to that used in Example 1 was etched for five minutes by an etching process similar to that performed in Example 1, except that the temperature of the process atmosphere was 700° C. The polysilicon film was substantially completely removed from the surface of the sample wafer, but residual polysilicon film was found in some parts of the surface of the sample wafer. Although the etch rate may well be though to be not lower than 45.6 nm/min, the etch rate may be around 45.6 nm/min because residual polysilicon film was found in some parts of the surface of the sample wafer.

### Example 3

A sample wafer similar to that in Example 2 was subjected to an etching process similar to that in Example 2, except that the etching process was continued for three minutes instead of five minutes. An etch rate estimated on the basis of the thickness of the polysilicon film remaining on the surface of the sample wafer was 15.4 nm/min.

### Example 4

A sample wafer similar to that in Example 2 was subjected to an etching process similar to that in Example 2, except that the etching process was continued for two minutes instead of five minutes. An etch rate estimated on the basis of the thickness of the polysilicon film remaining on the surface of the sample wafer was 4.4 nm/min.

### Example 5

A sample wafer having a surface coated with a 228 nm thick polysilicon film similar to that used in Example 1 was etched for five minutes by an etching process similar to that performed in Example 1, except that the temperature of the process atmosphere was 600° C. An etch rate estimated on the basis of the thickness of the polysilicon film remaining on the surface of the sample wafer was 0.52 nm/min.

### Example 6

A sample wafer having a surface coated with a 2280 Å thick polysilicon film similar to that used in Example 1 was etched for thirty minutes by an etching process similar to that performed in Example 1, except that the temperature of the process atmosphere was 500° C. The thickness of the polysilicon film did not change at all and the polysilicon film was not etched at all, i.e., etch rate was zero.

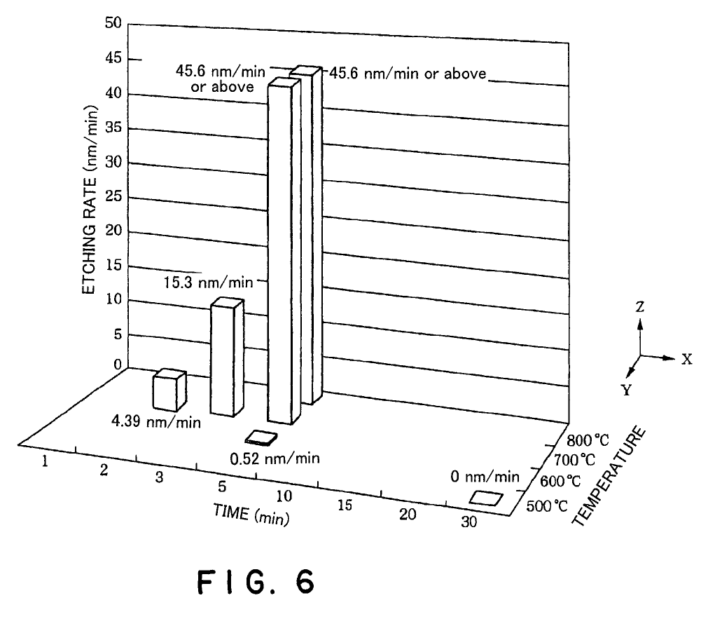

FIG. 6 is a three-dimensional graph showing the results of measurements obtained in Examples 1 to 6, in which processing time is measured on the X-axis, process temperature is measured on the Y-axis and etch rate is measured on the Z-axis. In FIG. 6, the height of a bar at the intersection of a line parallel to the Y-axis and intersecting the X-axis at a point corresponding to 5 min and a line parallel to the X-axis and intersecting the Y-axis at a point corresponding 700° C. represents an etch rate when the etching process was performed at a process temperature of 700° C. for 5 min.

When the process temperature is 700° C., the etch rates are low when the etching time is 2 min and 3 min. It is inferred that the etch rate is low because much time is spent for etching an oxide film formed by natural oxidation in the surface of the polysilicon film.

It is known from the measurements shown in FIG. 6 that the polysilicon films deposited on the inner surfaces of the reaction vessel and the wafer boat can be etched at a considerably high etch rate and can be quickly removed when the parts covered with the polysilicon films are heated at 700° C. or above when removing the polysilicon films by etching. Thus, 10 μm thick polysilicon films deposited on the inner surfaces of the reaction vessel can be removed even when the etch rate is 45.6 nm/min. If the surfaces are heated at, for example, 800° C., the polysilicon films can be etched at a higher etch rate and can be removed in a shorter time. The etch rate is very low when the process temperature is 600° C. and the polysilicon films are scarcely etched when the process temperature is 500° C. Therefore, it is preferable to heat the walls of the reaction vessel and the wafer boat at 700° C. or above to achieve the cleaning process satisfactorily.

### Example 7

The following experiments were conducted to verify that titanium nitride films deposited on the inner surfaces of the reaction vessel can be removed by a cleaning process using chlorine gas. A film forming process for depositing a titanium nitride film on wafers was repeated to deposit titanium nitride films on the inner surfaces of the reaction vessel. The thickness (overall thickness) of a part of the titanium nitride film thus formed and covering a middle part of the reaction tube (inner tube) was 1800 nm. An empty wafer boat was mounted on the cover and the reaction vessel was sealed hermetically. Then, an etching process was continued for 60 min, in which, the atmosphere in the reaction vessel was heated at 700° C., chlorine gas and nitrogen gas were supplied at 1800 sccm and 3200 sccm, respectively, into the reaction vessel and the pressure in the reaction vessel was maintained at 266 Pa (2 Torr). The reaction vessel was examined after the completion of the etching process and it was found that the titanium nitride films deposited on the inner surfaces of the reaction vessel were removed completely. An etch rate calculated simply by dividing 1800 nm by 60 min was as high as 30 nm/min. It is considered that the titanium nitride films were removed actually in a time shorter than 60 min and hence the actual etch rate may be higher than 30 nm/min. The experiments proved that chlorine gas is effective in cleaning the reaction vessel of titanium nitride films deposited on the inner surfaces of the reaction vessel by a film forming process of titanium nitride films or by an etching process of titanium nitride films.

### Example 8

A dummy wafer supporting thereon a 20 mm×40 mm×0.8 mm rectangular quartz chip was mounted on a wafer boat, and the wafer boat was placed in the reaction vessel. The quartz chip was kept for 3 hr in a chlorine gas atmosphere under the same process conditions as those in Example 1. Then, the weight of the quartz chip was measured. Change in the weight of the quartz chip was substantially zero. This experiment proved that the cleaning process using chlorine gas does not damage the quartz reaction tubes, quartz wafer boat and the quartz heat insulating tube at all.

What is claimed is:

1. A cleaning method comprising the steps of:
heating a reaction vessel so that inner surface thereof is heated at temperatures in a range of 700 to 1000° C.; and
supplying chlorine gas into the reaction vessel in order to make the chlorine gas react with deposits deposited on the inner surface of the heated reaction vessel, thereby removing the deposits therefrom.

2. The method according to claim 1, wherein the deposits are silicon films.

3. The method according to claim 1, wherein the deposits are titanium nitride films.

4. The method according to claim 1, wherein an interior space in the reaction vessel is maintained at a pressure in a range of 1 to 400 Torr when making the deposits react with chlorine gas.

5. A cleaning method comprising the steps of:
placing a holder, which is configured to hold an object to be processed, in a reaction vessel;
heating the reaction vessel and the holder so that an inner surface of the reaction vessel and a surface of the holder are heated at temperatures in a range of 700 to 1000° C.; and
supplying chlorine gas into the reaction vessel in order to make the chlorine gas react with deposits deposited on the inner surface of the heated reaction vessel and the surface of the heated holder, thereby removing the deposits therefrom.

6. The method according to claim 5, wherein the deposits are silicon films.

7. The method according to claim 5, wherein the deposits are titanium nitride films.

8. The method according to claim 5, wherein an interior space in the reaction vessel is maintained at a pressure in a range of 1 to 400 Torr when making the deposits react with chlorine gas.

9. A processing and cleaning method comprising the steps of:
(a) carrying out a process to a object in a reaction vessel;
(b) taking out the processed object from the reaction vessel;
(c) cleaning the reaction vessel, the cleaning step including the steps of:
heating a reaction vessel so that an inner surface thereof is heated at temperatures in a range of 700 to 1000° C.; and
supplying chlorine gas into the reaction vessel in order to make the chlorine gas react with deposits deposited on the inner surface of the heated reaction vessel, thereby removing the deposits therefrom.

10. The method according to claim 9, wherein the process in the step (a) is a film forming process for depositing a silicon film on the object or a dry etching process for etching a silicon film that has previously been formed on the object, and wherein the deposits are silicon films.

11. The method according to claim 9, wherein the process in the step (a) is a film forming process for depositing a titanium nitride film on the object or a dry etching process for etching a titanium nitride film that has previously been formed on the object, and wherein the deposits are titanium nitride films.

12. The method according to claim 9, wherein:
during the step (a), the object is held by a holder capable of being carried into and carried out of the reaction vessel;
in the step (b), the object is taken out of the reaction vessel while the object is held by the holder; and
the method further comprising the steps of:
(d) removing the processed object from the holder after the completion of the step (b), and
(e) placing the empty holder in the reaction vessel before the step (c);
wherein, in the step (c), the holder is also heated so that a surface thereof is heated at a temperature in a range of 700to 1000° C. and deposits deposited on the surface of the holder are removed therefrom by making the deposits react with chlorine gas.

13. The method according to claim 9, wherein an interior space in the reaction vessel is maintained at a pressure in a range of 1 to 400 Torr when making the deposits react with the chlorine gas in the step (c).
